(19) United States
(12) Patent Application Publication
(10) Pub. No.: US 2009/0270127 A1
(43) Pub. Date: Oct. 29, 2009

(54) MODEM CARD

(76) Inventor: Takashi Kakimoto, Kyoto (JP)

Correspondence Address: MCDERMOTT WILL & EMERY LLP, 600 13TH STREET, NW, WASHINGTON, DC, 20005-3096, US

(21) Appl. No.: 12/303,515

(22) PCT Filed: May 30, 2007
(86) PCT No.: PCT/JP2007/060966

§ 371 Date: Dec. 4, 2008

(51) Int. Cl. H04M 1/00; H04B 1/38

(52) U.S. Cl. 455/558; 375/222

(57) ABSTRACT

A communication unit communicates with an external communication device. An authentication unit authenticates a subscription right for communication. A position detector detects information of a current position. An interface carries out, according to a standardized signal mode, reception and transmission of input and output signals between an application device selected as a communication terminal from a group of application devices and the communication unit and the position detector.

### FIELD OF THE INVENTION

The present invention relates to a modem card which can be loaded in a mobile telephone terminal (inserted into a card slot thereof) or the like, a modem card utilization system in which the modem card is used, and application devices such as a mobile telephone terminal and an application device.

### BACKGROUND TECHNOLOGY

In a mobile telephone system wherein the W-CDMA system such as GSM (global system for mobile communication) is adopted, a one-chip IC card in which CPU is incorporated is used as a SIM card for authenticating a subscriber (IC card in which information of a subscription right (telephone number) is written). In such a mobile telephone terminal, the subscriber-related information is memorized in the SIM card. Therefore, when the model of the mobile telephone is changed, communication services set forth in a contractual coverage agreed on with a communication carrier can still be offered as soon as the SIM card is inserted therein, which is described below. In the mobile telephone terminal of the foregoing type, an application device feature for calls, communication, and the like, and a subscription right authentication feature granted to a user by the communication carrier are separated from each other. When the user purchases a mobile telephone, he/she selects the mobile telephone terminal and the communication carrier who provides the SIM card. The communication carriers sell the SIM cards. When the user signs a contract with the communication carrier, he/she receives the SIM card. The user attaches the received SIM card to the mobile telephone terminal purchased irrelevant to the communication carrier and thereby is allowed to use the mobile telephone terminal. When another mobile telephone terminal is used, the user removes the SIM card from the previous mobile telephone terminal and inserts it into that other mobile telephone terminal. Accordingly, the same telephone number can be used in that other mobile telephone terminal.

Thus, a plurality of mobile telephone terminals can be used with the same telephone number when the SIM card is used. Music communication and data communication are available via public wireless networks in various information terminals and information devices (hereinafter, referred to as application device) such as a laptop PC (personal computer) and PDA (personal digital assistant), and it is desired that a SIM card is used too in these application devices other than the mobile telephone.
PATENT DOCUMENT 1: 2001-069260 of the Japanese Patent Applications Laid-Open
PATENT DOCUMENT 2: 2001-245344 of the Japanese Patent Applications Laid-Open
PATENT DOCUMENT 3: 2001-258071 of the Japanese Patent Applications Laid-Open

### DISCLOSURE OF THE INVENTION

### Problems To Be Solved By The Invention

However, it is conventionally not possible to directly attach the SIM card to these application devices in order to use it in these devices. It is necessary to purchase a SIM card adapter which can be mounted in these application devices (for example, adapter designed for PCMCIA card), load the SIM card in the adapter, and attach the adapter to the application devices so that the SIM card can be used therein. On the other hand, such an adapter is not necessary in most of the mobile telephones. Therefore, in order for the SIM card to be usable in both of the application device and the mobile telephone, the SIM card has to be repeatedly inserted into and removed from the adapter, which is very inconvenient for the user.

In order to avoid the inconvenience, it is necessary to sign another contract for the application device apart from the contract for the mobile telephone, which unfavorably makes the management of information complicated and increases a burden in term of costs. Further, different telephone numbers will be necessary for the two contracts.

Further, mobile telephones which were recently launched into the market are provided with a position detection feature. The position detection feature includes the detection of the location of the user or the bearer of the application device. On the other hand, the position detection feature is not provided in many of the application devices, and the application device may become more costly and grow in size in the case where the position detection feature is provided therein. Further, in the case where the user owns a plurality of application devices, it is redundant and wasteful to provide the position detection feature in all of the application devices.

Further, the application device may be provided with a system or a navigation system wherein positional information is detected (obtained) via the GPS (global positioning system) or an interconnection between base stations and regional information associated with the detected positional information (area map, restaurant and shopping information, and the like) is offered. In these systems, the information is downloaded in advance from an external recording medium such as DVD or CD or via the Internet into a hard disc in the application device, or sequentially read from the external recording medium, and then used by means of an application installed in the application device. When the information thus recorded in the hard disc of the application device is used in another application device (including the mobile telephone), data has to be separately transferred via cable or wirelessly. In such a case, the coordination of data transfer between the two application devices, for example, becomes necessary, and the application device where the data is retained and the application device to which the data is transferred should be placed in close proximity to each other. Thus, a structure which satisfies all of these demands is inevitably complicated, which may undermine the mobility of the devices.

Therefore, a main object of the present invention is to inexpensively perform audio communication and data communication in a simplified management process between a plurality of different devices (mobile telephone terminal and another application device, or the like) based on a contract for a single communication line agreed on with a communication carrier.

### Means For Solving The Problems

In order to achieve the foregoing object, a modem card according to the present invention comprises
a communication unit for performing communication with an external communication device;
an authentication unit for authenticating a subscription right for communication;
a position detector for detecting information of a current position; and
an interface for transmitting and receiving input and output signals between an application device selected as a communication terminal from a group of application devices and the communication unit and the position detector based on a standardized signal mode.

The information of the current position refers to information of a position where the modem card is currently located.

A SIM may constitute the authentication unit. Information in the SIM refers to information of a contract singed by a user such as information relating to the communication connection such as a telephone number, information of the connection to a GSM network, password and the like, and these pieces of information are authenticated.

A UIM (user identity module) or an IC interface card may be used in place of the SIM. The UIM card is called a USIM card and is a third-generation mobile telephone card extended based on the SIM card used in a GSM mobile telephone terminal, and therefore may simply be called the SIM card. Such personal information as a telephone number is recorded in the UIM card.

Examples of the application device include, in addition to an information mobile terminal, a desktop computer, a laptop computer, a mobile telephone terminal, an audio device, a home electric appliance, and the like, though not particularly limited.

The position detector is not particularly limited as far as it can provide the positional information. Preferable examples of the position detector are the 3-point positioning system in which electric waves from a base station of the mobile telephone are utilized, hyperbolic navigation system, system in which RFID is utilized, system in which WiFi electric waves are utilized, and the like, which were so far devised. However, the GPS (global positioning system) is suitably adopted. The GPS is a system by which your exact location on the earth is determined via an artificial satellite. As the position detector may be adopted a satellite positioning system (SPS) such as the Global Navigation Satellite System (GLONASS) in Russia or the Galileo System in Europe other than the GPS.

A SDIO (secure digital input/output) card may constitute the modem card. The SD (secure digital) memory card is a memory card in which a copyright protection feature suitable for the on-line music distribution is integrated. The SDIO card is the SD card compliant with the small-size memory card specification further provided with various features. The SDIO card may be either a SD card or a mini SD card. Alternatively, a PC card, CF (compact flash), and the like compliant with the semiconductor card specification may be used in place of the SDIO card.

According to the modem card provided by the present invention, the input and output signals are controlled between the application device selected as the communication terminal from the group of application devices and the communication unit and the position detector by the interface based on the standardized signal mode. Therefore, the modem card can be shared and used by a plurality of application devices, and audio communication, data communication, and the like can be realized after each application devices with the modem card loaded therein is authenticated (the user is authenticated) by the authentication unit. In other words, the audio communication, data communication, and the like can be performed by a plurality of application devices based on a contract for a single communication line for the modem card agreed on with a communication carrier. Further, since the modem card is provided with the position detector, the positional information can be obtained by the application device in which the modem card is loaded.

The modem card according to the present invention preferably further comprises:
a connection terminal portion which has terminals standardized so as to be coupled with all of the application devices constituting the group of application devices and which is to be coupled with any of the application devices through the terminals so that the signals are transmitted and received therebetween, wherein
the authentication unit authenticates the subscription right for communication of the user via the communication unit by contacting a communication device of a communication carrier which is an example of the external communication device, and
the position detector provides the information of the current position to the application device via the interface.

The modem card according to the present invention preferably further comprises:
a first memory for memorizing information relating to features of the application device; and
a power supply for supplying power for sustaining the first memory to the first memory.

The information relating to the features of the application device is, for example, call-arrival status in the audio communication. Accordingly, the information relating to the call-arrival status in the audio communication can be retained by means of the modem card in the case where, for example, the modem card is attached to an application device which does not support the audio communication, and the audio communication can be performed based on the retained call-arrival information when the modem card is attached to an application device which supports the audio communication.

The modem card according to the present invention preferably further comprises a second memory for memorizing an incoming-call register in the audio communication. Once the incoming-call register is thus stored, even if the application device does not support the audio communication or it is not possible to immediately respond to the incoming call, the following processing or measures can be implemented:
attach the modem card to the application device which supports the audio communication later; or
wait until it becomes possible to respond to the call.

As a result, a return call can be immediately made based on the incoming-call register stored in the second memory.

The modem card according to the present invention preferably further comprises a detector for detecting the fact that the modem card is illegally removed from the application device without procedures predetermined on the application-device side, wherein
the communication unit transmits the detection result obtained by the detector to a receiver of a predetermined institution previously registered as a recipient of the detection result. Thus constituted, when the modem card is illegally removed from the application device without procedures predetermined on the application-device side, the removal is detected and reported to the receiver of the predetermined institution. As a result, such a possible problem as theft can be prevented from happening.

The modem card according to the present invention preferably further comprises a third memory for storing data used for application software installed in the application device. Thus constituted, the information which can be shared and used by a plurality of application devices is recorded on the modem card, and the information can be shared and used by the application devices when the modem card is removed from one of the devices and attached to another. Accordingly, it becomes unnecessary to transfer data under a complicated process between the application devices, and to place the application device in which the data is stored and the application device to which the data is transferred in close proximity to each other. As a result, the user finds it more convenient to use the application devices.

According to the present invention, the communication unit preferably downloads the data from the Internet and store the downloaded data in the third memory. Thus constituted, the communication unit provided in the modem card can obtain the data used in the application device without connecting the modem card to any other device.

According to the present invention, the data is preferably fetched into an arbitrary external device from an external recording medium such as CD-ROM or the Internet and transferred to the third memory from the external device. Thus constituted, in the case where the information which needs to be used in the application device is stored on the external device such as CD alone, for example, the necessary data can be fetched into the modem card via an arbitrary device (for example, personal computer, hereinafter referred to as PC) capable of reading the information from the external recording medium such as CD. Further, when the communication feature of the modem card is not used, and the information downloaded into the PC via the Internet in advance is transferred to the modem card, a fee charged on the data communication can be reduced.

According to the present invention, the data preferably includes any of map information, sightseeing spot information, transportation service information and shopping information. Thus constituted, useful information can be supplied from the modem card according to the present invention to the user while he/she is traveling.

The modem card according to the present invention preferably further comprises a data transfer unit for extracting the data relating to the information of the current position detected by the position detector from the third memory and transferring the extracted data to the application device. Thus constituted, the information based on the location of the bearer of the modem card comprising the third memory can be offered. Therefore, useful information at any arbitrary site can be offered as he/she moves. Further, the arbitrary information can be combined with contents produced by the user him/herself, such as photographs in a digital camera which is an example of the application device, and then the combined data can be memorized in the application device.

In a modem card utilization system in which the modem card according to the present invention is used, the modem card extracts the data from the third memory based on a user's instruction and transfers the extracted data to the application device, and the application device appends the data transferred from the modem card to contents which will be data-processed by the application device.

According to the modem card utilization system in which the modem card according to the present invention is used, of the data stored in the third memory of the modem card, any arbitrary information desired by the user in the application device is selected and outputted to the application device, and the arbitrary data read from the modem card can be appended to the contents on the application-device side, for example, the arbitrary data transferred from the modem card (textual information or the like) is multi-displayed on an image being reproduced on a monitor of the application device.

In the modem card utilization system in which the modem card according to the present invention is used, the modem card by which the communication via a public radio network is realized based on the contract for a single communication line with the communication carrier is used, and the modem card is shared and used by a plurality of application devices for the communication via the public radio network.

In the modem card utilization system in which the modem card according to the present invention is used, the communication of audio, data and the like can be realized in a plurality of application devices based on the contract for a single communication line with the communication carrier for the modem card, and the information of the subscription right such as a telephone number can be shared by the application device and the mobile telephone and thus easily managed, and cost reduction is realized in comparison to such a case that a plurality of contracts are agreed on with the communication carrier. Further, the positional information can be easily offered in each of the application devices without any increase in the cost and size because the position detector is provided in the modem card.

An application device according to the present invention comprises a card slot to which the modem card is connected. According to the present invention, the audio communication and the data communication can be realized between the mobile telephone application device and another application device under the contract for a single communication line with the communication carrier, the information of the subscription right such as a telephone number can be easily managed, and the contract for a single communication line with the communication carrier results in the cost reduction. Further, because the modem card is provided with the position detector, application devices other than the mobile telephone can provide position information features inexpensively without increasing their sizes.

### BRIEF DESCRIPTION OF THE DRAWINGS

FIG. 1 is a block diagram of a modem card according to a preferred embodiment of the present invention.

FIG. 2 is a block diagram illustrating a controller and a communication unit illustrated in FIG. 1.

FIG. 3 is a broken perspective view of a hardware configuration of the modem card illustrated in FIG. 1.

FIG. 4 is an illustration of a system where the modem card illustrated in FIG. 1 is used.

FIG. 5 is an illustration of the modem card illustrated in FIG. 1 provided with a memory having a large capacity.

FIG. 6 shows examples of data stored in the large-capacity memory.

FIG. 7 is an illustration of a system where the modem card illustrated in FIG. 5 is used.

FIG. 8 is an illustration of a system where the modem card illustrated in FIG. 5 is used.

### DESCRIPTION OF THE REFERENCE SYMBOLS

10 modem card
11 connection terminal portion
12 interface
13 power supply controller
14 controller
15 authentication unit
16 position detector
16a positioning antenna
16b positioning receiver
16c positioning algorithm processor
17 communication unit
17a RF antenna
17b RF transceiver
18 large-capacity memory

### PREFERRED EMBODIMENT OF THE INVENTION

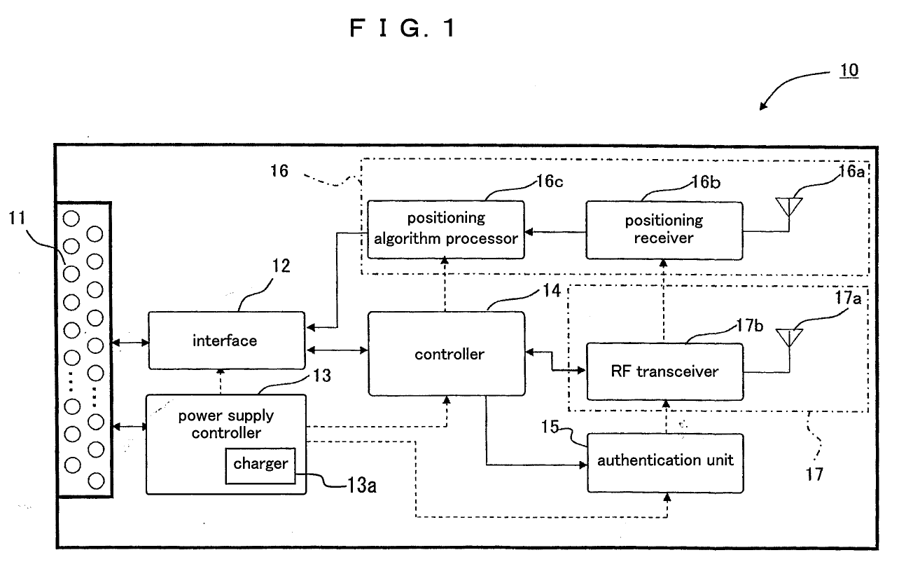

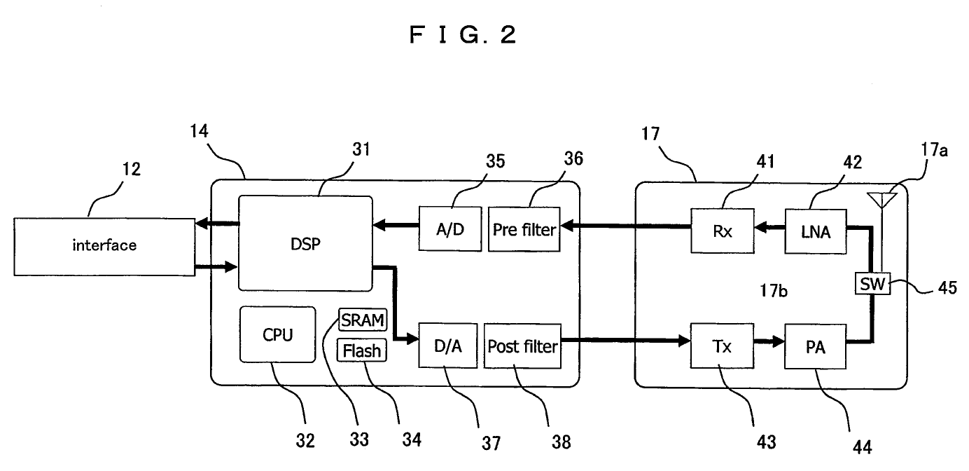

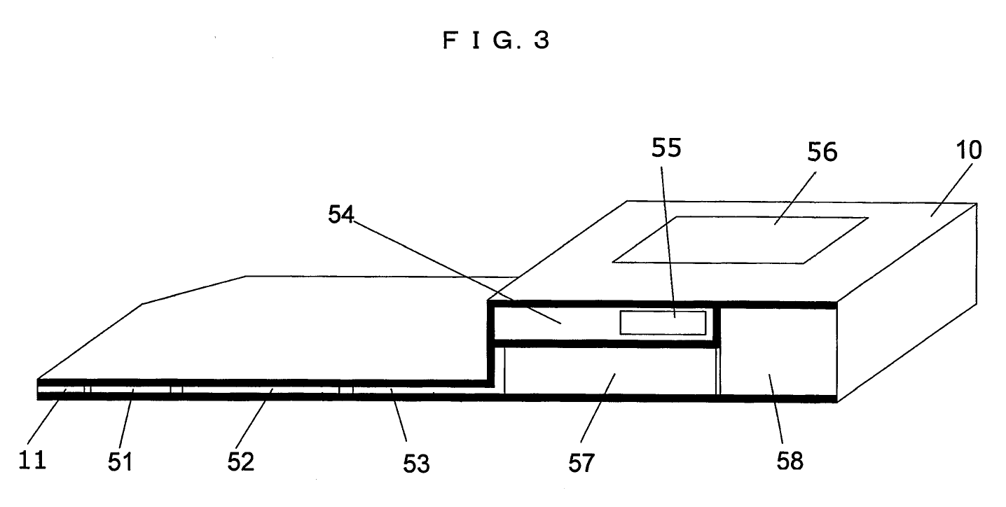

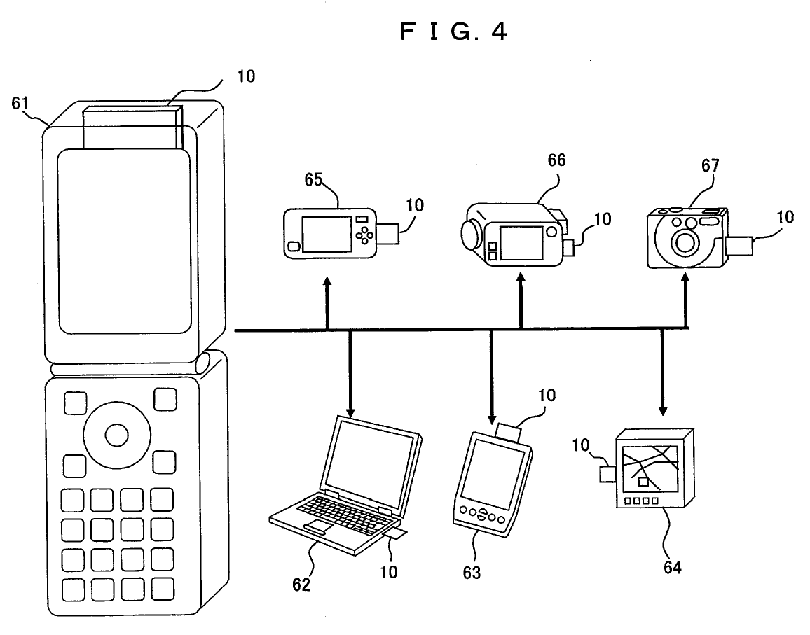

A preferred embodiment of the present invention is described referring to FIGS. 1-4. FIG. 1 is a block diagram of a modem card. FIG. 2 is a drawing specifically illustrating a part of the modem card. FIG. 3 is a broken perspective view of the modem card. FIG. 4 is an illustration of a modem card utilization system wherein the modem card is used.

A modem card 10 according to the present preferred embodiment has a rectangular shape in a planar view which can be inserted into a memory card slot of an application device. The modem card 10 having such a shape comprises a connection terminal portion 11 on an insertion-end side thereof in a longitudinal direction, from which side the modem card 10 is inserted into the memory card slot. The application device comprising the memory card slot is not particularly limited; however, examples of the application device are an information mobile terminal, a desktop computer, a laptop computer, a mobile telephone, an audio device, a home electric appliance, and the like.

The modem card 10 comprises, in the connection terminal portion 11 thereof, a large number of terminals provided in two rows and connected to a large number of connecting points in the card slot of the application device. A one-chip microcomputer mainly constitutes the modem card 10. In FIG. 1, as the modem card 10, the one-chip microcomputer and its features are illustrated in blocks. The modem card 10 is provided with an interface 12, a power supply controller 13, a controller 14, an authentication unit 15, a position detector 16, and a communication unit 17.

The interface 12 is provided to standardize signals in the modem card and perform the input and output of signals of packet data, audio data and the like between itself and the application device.

The power supply controller 13 includes a charger 13a and preferably includes a high-capacity charger (power cap) such as an electric double layer capacitor, and thereby reliably supplies power to all of the functional blocks and devices in the modem card 10. The controller 14 controls the blocks in the modem card. The authentication unit 15 executes processing such as a user authentication and a device authentication for a SIM card, a UIM card, an IC card and the like. The modem card 10 is provided with SIM features since the authentication unit 15 is provided therein.

The position detector 16 comprises a positioning antenna 16a, a positioning receiver 16b and a positioning algorithm processor 16c. The positioning antenna 16a is a small-size antenna which receives RF carrier waves of a positioning signal from a GPS satellite or the like. The positioning receiver 16b performs receiving processing of RF carrier waves of a satellite signal from the GPS satellite or the like. The positioning algorithm processor 16c processes the satellite signal transmitted from the GPS satellite to thereby extract the positional information of the application device in which the modem card 10 is loaded. The position detector 16 thus constituted comprises GPS (global positioning system) features.

The communication unit 17 comprises an RF antenna 17a and an RF transceiver 17b. The RF antenna 17a is a small-size antenna which transmits and receives RF carrier waves of a public radio signal. The RF transceiver 17b transmits and receives the RF carrier waves. Arrows which connect the respective blocks illustrated in solid lines denote the flow of various signals, and arrows which connect the respective blocks illustrated in broken lines denote the control of the power supply.

When the modem card 10 thus constituted is inserted into the memory card slot of the application device, the application device with the modem card 10 loaded therein can directly access a public wireless network. Therefore, when the modem card 10 is loaded in a plurality of application devices one after another, the public wireless network can be accessed via the plurality of application devices under a single contract agreed on with a communication carrier.

The modem card 10 which is inserted into a memory card slot of an application device which is in want of the public wireless network communication feature and connected thereto can be shared between the application device and a mobile telephone application device having the public wireless network communication feature.

The modem card 10 is provided with a packet communication feature, an audio communication feature, a system power supply stabilization feature, a communication interface feature, SIM features including a subscriber authentication feature of a mobile telephone system, a GPS feature for obtaining the positional information of the mobile telephone from a satellite, and the like. The application device in which the modem card 10 having these features is loaded can wirelessly communicate with the outside.

The system where the modem card 10 is utilized has the following features. In a state where the modem card 10 is removed from the memory card slot of the application device, the controller 14 controls features described below by controlling the power supply controller 13, position detector 16, communication unit 17, and authentication unit 15:
a feature to retain features desired by the user such as receiving calls;
a feature to notify a third person of the removal of the modem card 10 from the memory card slot by means of the application device when it is detected that the modem card 10 is removed from the memory card slot without going though proper procedures determined in advance;
a feature to record incoming calls on the modem card 10 and call callers based on the recorded incoming calls even when the modem card 10 is loaded at that time in any other application device; and the like.

These features are implemented for a limited period of time by means of power charged in the modem card 10.

Referring to FIG. 2, the constitutions of the controller 14 and the communication unit 17 are described. The controller 14 comprises, for example, a DSP (digital signal processor) 31, a CPU 32, a SRAM (static random access memory) 33, a flash memory 34, an A/D converter 35, a pre-filter 36, a D/A converter 37, and a post-filter 38.

The communication unit 17 comprises the RF antenna 17a and the RF transceiver 17b. The RF transceiver 17b comprises an Rx (receiver) 41, an LNA (low noise amplifier) 42, a Tx (transmitter) 43, a PA (power amplifier) 44, and a SW (switch) 45 which switches between the transmission and reception done by the RF antenna 17a.

When the switch SW 45 switches to the reception side (Rx 41), the signal received by the RF antenna 17a is outputted to the RF transceiver 17b in the communication unit 17. In the RF transceiver 17b, the LNA 42 amplifies the received signal, and the Rx 41 provides receiving processing to the amplified received signal and outputs the processed received signal to the controller 14. In the controller 14, the pre-filter 36 filtering-processes the received signal, and the AD converter 35 AD-converts the filtering-processed received signal. The AD-converted received signal is outputted to the DSP 31. The DSP 31 DSP-processes the AD-converted received signal (hereinafter, referred to as a digital signal) and outputs the processed signal to the interface 12. In the controller 14, when the digital signal is inputted to the DSP 31 from the interface 12, the DSP 31 DSP-processes the inputted digital signal in a predetermined manner, DA-converts the DSP-processed digital signal in the DA converter 37, and filtering-processes the DA-converted digital signal in the post-filter 38, and then, outputs the processed digital signal to the communication unit 17. In the communication unit 17, the switch SW 45 switches to the transmission side (Tx), and the processed digital signal is transmitted via the Tx (transmitter) 43 and PA (power amplifier) 44 of the RF transceiver 17b and RF antenna 17a.

In the constitution described above, the controller 14 comprising the CPU 32, SRAM 33 and flash memory 34 executes the foregoing features. The controller 14 and the communication unit 17 thus far described will not be described in further detail. The SRAM 33 and the flash memory 34 in the controller 14 serve as first and second memories, respectively, in which call-arrival status and an incoming-call register are stored.

A hardware configuration of the modem card 10 is described referring to FIG. 3. FIG. 3 is a perspective view of the modem card 10 which is cut along a side surface thereof. The connection terminal portion 11 is not shown in the drawing. The modem card 10 according to the present preferred embodiment is a SDIO modem card which is used when inserted into a memory card slot having the same shape as that of SD memory cards of various application devices.

51 denotes a SDIO LSI corresponding to the digital signal interface 12. 52 denotes a BB (base band) LSI corresponding to the controller 14. 53 denotes a PM (power management) IC for regulating the power supply, which corresponds to the power supply controller 13. 54 denotes an RF module corresponding to the communication unit 17. 55 denotes a GPS receiver corresponding to the position detector 16. 56 denotes a SIM corresponding to the authentication unit 15. The SIM 56 in which subscription right information (telephone number) is written is detachable so that a manufacturer can write information therein. 57 denotes a power cap (electric double layer capacitor). 58 denotes an ANT (antenna). The antenna 58 corresponds to the antenna 16a of the position detector 16 and the antenna 17a of the communication unit 17.

FIG. 4 illustrates a digital home electric appliance ubiquitous net modem card utilization system which is an example of a modem card utilization system wherein the modem card 10 according to the present preferred embodiment is used. The modem card 10 is removed from a memory card slot of a mobile telephone terminal 61, and loaded in a card slot (for example, SD memory card slot) of an application device such as a PC 62, a PDA63, a car navigation device 64, a game machine 65, a video camera 66, or a digital camera 67. The application devices 61-67 are each provided with the card slot having a common structure in which the modem card 10 can be loaded. When the modem card 10 is inserted therein, the application devices 61-67 can directly access a public wireless network to thereby perform the audio communication, data communication, and the like.

After a contract for a single communication line is made with the communication carrier for the use of the mobile telephone terminal 61, through the use of the modem card 10, not only the mobile telephone terminal 61 but also other application devices 62-67 can respectively perform the communication via the public wireless network according to the SIM features provided in the modem card 10 by simply inserting the modem card 10 into the card slot of the mobile telephone terminal 61 and any of the other applications 62-67.

When the modem card 10 having the public wireless network communication feature obtained under a contract with the communication carrier is thus connected to the application devices 62-67 which are in want of the public wireless network communication feature, the public wireless network communication feature can also be used by the application devices 62-67. Therefore, the audio communication and the data communication are realized in each of the application devices 61-67 through the contract alone for a single communication line with the communication carrier, the subscription right information such as a telephone number can be easily managed, and the cost can be reduced since only the contract with the communication carrier is required.

Further, the information of the current position offered to the mobile telephone terminal 61 can also be used in the application devices 62-67 free of charge when the modem card 10 having the GSP feature is loaded in the mobile telephone terminal 61 and the application devices 62-67. Further, the application devices 62-67 can be prevented from increasing in size since the position detector 16 is provided in the modem card 10.

Further, the modem card 10 handles the digital information, which is advantageous in that the data inputted and outputted between the application devices 62-67 including the mobile telephone terminal 61 via the interface 12 is hardly affected by noises. Further, the modem card 10, which is the SDIO modem card, can be downsized, which results in the downsizing of the application devices 62-67 including the mobile telephone terminal 61.

In addition to the basic constitution thus constituted, the constitution for the retention of features, retention of an incoming-call register, feature halt/notification under abnormal circumstances, and a memory having a large capacity can be provided whenever necessary. First, the retention of features is described. When the modem card 10 is loaded in the application devices (mobile digital home electric appliances) 62-67 other than the mobile telephone terminal 61, there is a case where the application devices 62-67 can handle packet data communication, but can not support audio communication. In such a case, the call-arrival status is retained for a while until the modem card 10 is loaded in the application device which can support audio communication (for example, mobile telephone terminal 61) so that a call can be made immediately thereafter. It is assumed that the power cap 57 is supplied with certain charges. More specifically, suppose that audio communication is received when the modem card 10 is loaded in any of the application devices 62-67 which do not support the audio communication. In that case, the modem card 10 detects the arrival of a call using the RF antenna 17a, and the controller 14 is notified of the call arrival from the RF transceiver 17b. Then, the call-arrival status is set in a register in the SRAM 33 serving as the first and second memories. While the RF transceiver 17b is detecting the call arrival, the call-arrival status set in the register is retained, and released when the call is cut off.

The power cap 57, which is the power supply, is provided in order to reliably supply power to the modem card 10. More specifically, a momentary electric power at a transmission time often exceeds a maximal rating of the power supplied to the modem card 10, and therefore, the power cap 57 is provided so that the power will not exceed an average allowable power supplied from outside of the card in such a way that power is constantly charged in the power cap 57 at any time other than a transmission time, and the power charged in the power cap 57 is used when the maximal power at a transmission time exceeds the average power supplied to the card.

When the modem card 10 is removed from the application devices 62-67, the modem card 10 detects the removal, and the power cap 57, which is the power supply, is instructed by the CPU 32 to feed power to the PMIC 53. The PMIC 53 feeds power to the SRAM 33 and the RF transceiver 17b, so that the call-arrival status of the modem card 10 is retained.

When the modem card 10 is thereafter connected to the device supporting audio communication (for example, mobile telephone terminal 61), the modem card 10 detects the connection, and the CPU 32 checks the register in the SRAM 33 where the call-arrival status is set. In the case where the call-arrival status is detected, the modem card 10 notifies the application device 61 of the call-arrival status according to the instruction from the CPU 32, and the user can immediately start his/her speech.

In the foregoing example, the retention feature in the application device is used to protect the call-arrival status in audio communication; however, is not necessarily limited thereto. Arrival status in packet data communication in the application device which does not support the packet data communication, for example, may be retained. For example, it is assumed that information of newly released or newly arrived music is received from a music or video download site. In that case, the user may wish to immediately download the received information, which is, for example, free contents. However, in the case where that the application device in which the modem card is loaded is unsuitable for the reproduction of the contents to be downloaded, it is not possible to reproduce the desired contents. In that case, the modem card 10 is loaded in an application device suitable for the reproduction while the packet-arrival status is retained, and the download of contents is started. As a result, the desired contents can be reproduced on the selected application device.

Next, the retention of the incoming-call register is described. The retention of the incoming-call register is described referring to a case where a call is received in the audio communication while an application device not supporting audio communication is being used, and a case where it is not possible to immediately respond to the incoming call even though the application device supporting the audio communication is used. In that case, after the incoming-call register is stored in the modem card 10 so that a return call can be made, the modem card 10 is connected to the device capable of the audio communication, a return call can be made.

More specifically, when the audio communication is received in the state where the modem card 10 is inserted in the application devices 62-67 incapable of the audio communication, it may not be possible to immediately respond to the communication. In the modem card 10, the incoming call is detected by the RF antenna 17a, and the arrival of the call is notified to the controller 14 from the RF transceiver 17b. Then, the notified contents are recorded in the flash memory (first and second memories) 34 as a incoming-call register (telephone number, date and time, and the like).

When the modem card 10 is thereafter connected to a device capable of the audio communication (for example, mobile telephone terminal 61), the modem card 10 detects the changed connection, and checks if there is data in the incoming-call register in the flash memory 34. In the case where a incoming-call register is detected, the information of the incoming-call register is transmitted to the application device 61 from the modem card 10 according to the instruction by the CPU 32, and the user can make a return call.

Next is described feature halt/notification under abnormal circumstances. When the modem card 10 is removed from an application device without procedures predetermined on the application-device side, the modem card 10 detects the unauthorized removal, and notifies a predetermined institution of the removal, and then takes measures such as the halt of the feature of the modem card 10 (theft prevention feature).

For example, the modem card 10 can be adapted such that the IC card feature may be provided in an IC chip having the SIM feature. Therefore, when the modem card 10 is removed from the application device without procedures predetermined on the application-device side, the removal is detected by the controller 14 which is a detector. The controller 14 contacts a receiver of a company (predetermined institution) in charge of billing and settlement of a card company or the like, which supplies the IC card feature, via the RF transceiver 17b and the RF antenna 17a which serve as notification units, and informs them of the unauthorized removal. Unless a notification from the user claiming that the removal was not due to theft is received within a predetermined time period, the IC card and SIM features and the like appended to the modem card 10 are halted. More specifically, when the receiver of the card company receives the information of the unauthorized removal transmitted from the modem card 10, a subscriber management device of the card company (hereinafter, simply referred to as a card company) identifies the modem card 10 which transmitted the information of the unauthorized removal (that is the user), and records the information of the unauthorized removal in the management information of the modem card 10. After that, the card company makes preparations for the halt of the IC card and SIM features of the modem card 10, and also notifies the user of the halt using some method previously set. Unless the user makes a notification claiming that the removal was not unauthorized within a certain period of time after the previous notification, the foregoing features of the modem card 10 are completely halted. Alternatively, the IC card and SIM features of the modem card 10 may be authenticated when an authorized user or an unauthorized user executes these features during the period when the halt of the features is prepared. In that case, the card company notifies the user of the modem card 10 of the “detection of the unauthorized removal”, and authenticates the user (more specifically, modem card 10) according to some sort of method, and then, authorizes the execution of the features in the modem card 10 after the authentication is completed and it is confirmed that the removal is not unauthorized.

In the case where the modem card 10 used by an employee of a corporation who handles confidential matters is stolen, for example, the modem card 10 may be removed from the application device without procedures predetermined on the application-device side. In that case, the following processing can be executed.

When the unauthorized removal of the modem card 10 is detected by the controller 14 which is a detector, the controller 14 communicates a request for the invalidation of the modem card 10 to a communication device of the corporation (predetermined institution) via the RF transceiver 17b and the RF antenna 17a which are the notification units, and invalidates the modem card 10 after a predetermined time has passed after the notification. More specifically, in the case where a security level of the application device in which the modem card 10 is loaded is set to a high level, the controller 14 invalidates the modem card 10 in cooperation with the IC card company immediately after the modem card 10 is removed. The modem card 10 may be automatically invalidated in the case where the invalidation request due to the removal without permission is transmitted to the communication device of the corporation (predetermined institution) from the modem card 10 and the communication device of the corporation (predetermined institution) or the card company is not notified from the modem card 10 that the removal is authorized (it is necessary to authenticate the user) within a predetermined amount of time.

In the feature retention and the retention of the incoming-call register, the call-arrival status and the incoming-call register are stored in the SRAM 33 or the flash memory 34 of the controller 14; however, may be stored in a SRAM or a flash memory outside the controller 14.

Next, a large-capacity memory is described. In the case where common data can be used by a plurality of application devices to which the modem card 10 is connected, a large-capacity memory (third memory) may be provided in the modem card 10. In so doing, data obtained from the Internet via the communication unit is stored in the large-capacity memory, and the modem card 10 in which the data is stored can be loaded in the various application devices. As a result, the modem card 10 can transfer the data to the application devices in which the modem card 10 is loaded. In other words, the data can be shared by a plurality of arbitrary application devices when the modem card 10 is removed from one device and attached to another.

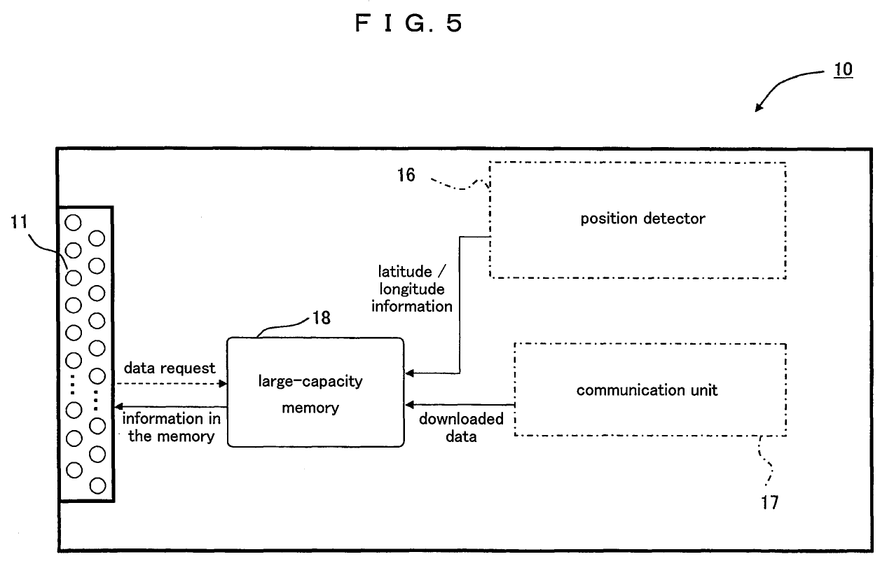

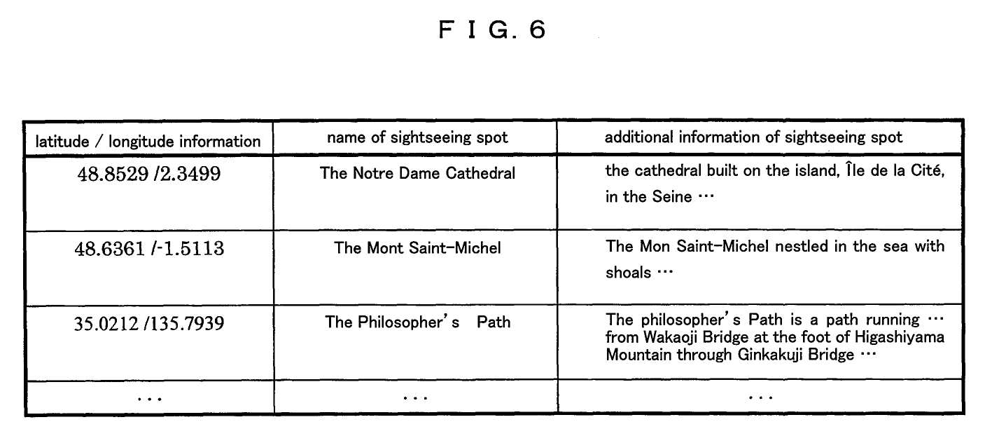

In the foregoing constitution, the information of the current position of the bearer of the modem card may be obtained via the position detector, so that data based on the current positional information is selected from the data stored in the large-capacity memory and transferred to application devices. More specifically, the modem card 10 inserted in the digital camera 67 (application device) as shown in FIGS. 4 and 5 obtains data from the Internet via the communication unit 17, and stores the obtained data in a large-capacity memory 18. The data obtained at the time is a database in which sightseeing spot information as shown in FIG. 6 is combined with information of a geographical position (latitude/longitude) where the relevant sightseeing spot is located. When the user accesses the application software installed in the digital camera 67 in a predetermined manner, the digital camera 67 requests the modem card 10 to provide the information based on the current position. In response to the request, the modem card 10 transfers the sightseeing spot information based on the positional information obtained via the position detector 16 to the application software of the digital camera 67 from the large-capacity memory 18. The controller 14 controls the data transfer. In this constitution, the controller 14 constitutes a data transfer unit. When the information of the latitude/longitude “48.85/2.35” is obtained via the position detector 16, for example, “the Notre Dame Cathedral” which is the nearest sightseeing spot based on the positional information obtained from the database in the large-capacity memory 18 is selected, and the title of the selected sightseeing spot and additional information are transferred from the modem card 10 to the digital camera 67. A monitor of the digital camera 67 displays data based on the information transferred from the large-capacity memory 18 illustrated in FIG. 17.

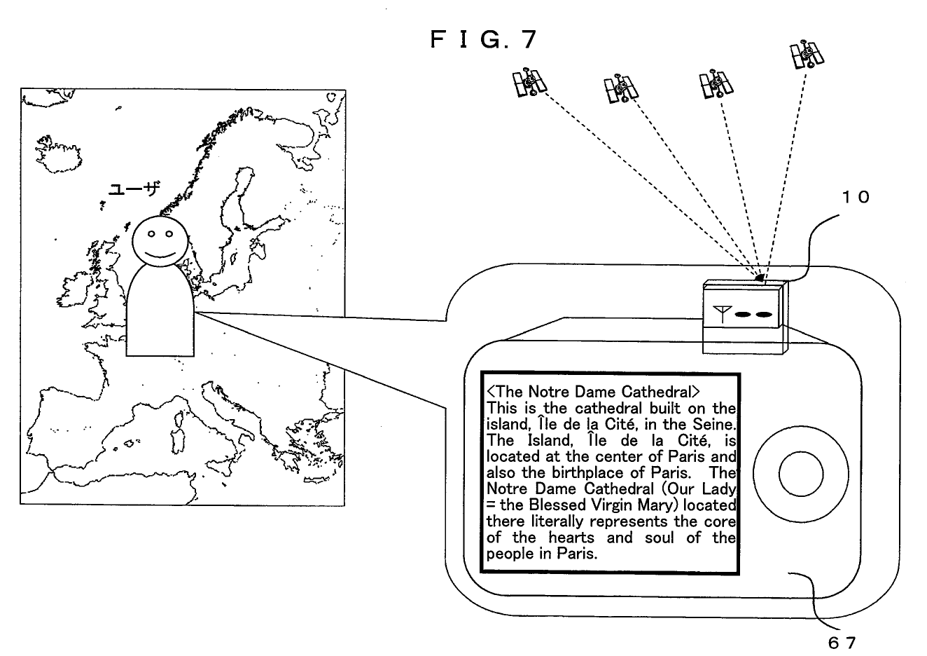

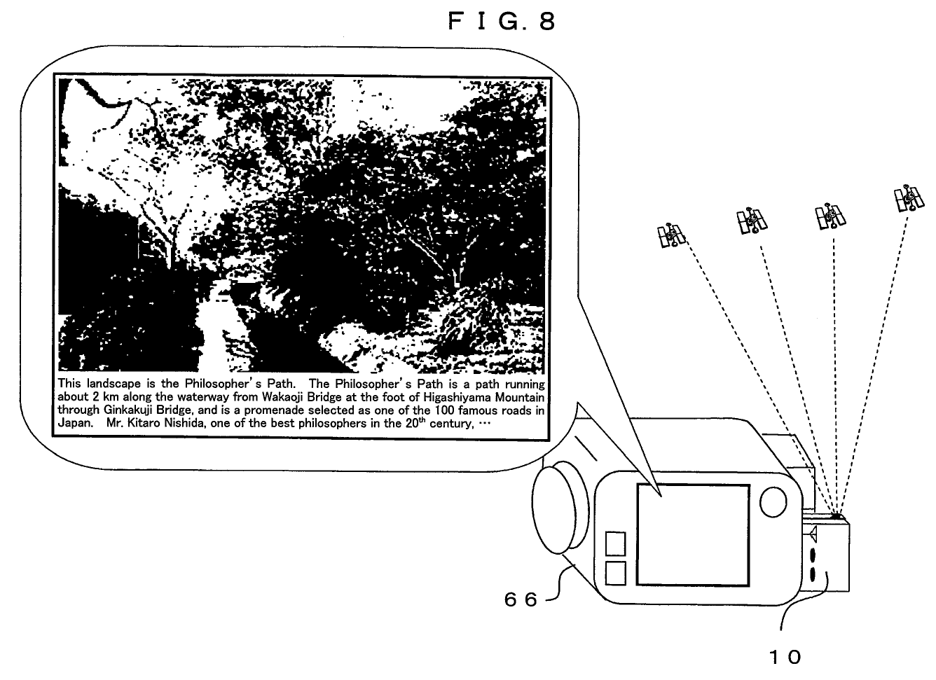

In the example illustrated in FIG. 7, the monitor displays only the textual information obtained from the large-capacity memory 18; however, may display contents retained in the application device with the information obtained from the large-capacity memory 18 attached thereto. For example, the information based on a location where moving images are obtained is transferred from the modem card 10 to the digital video camera 66 while the moving images are being shot by the camera 66, and the transferred information can be superimposed on the images currently obtained and then displayed. In the digital video camera 66 illustrated in FIG. 8, a description of the location where the moving images are obtained is displayed on the monitor together with the moving images currently obtained.

In the foregoing example, the data is fetched into the large-capacity memory 18 via the communication unit 17 of the modem card 10; however, may be previously fetched into the large-capacity memory 18 of the modem card 10 via an arbitrary device such as PC. Further, the type and amount of the information to be stored may be increased or decreased depending on the capacity of the large-capacity memory 18. FIG. 5 illustrates only the blocks which are necessary for the description of the constitution wherein the large-capacity memory 18 is provided, and the basic constitution and operation of the modem card 10 are similar to those illustrated in FIG. 1.

As illustrated in the examples of the digital camera 67 and the digital video camera 66, in the system wherein the modem card 10 according to the present invention is used, the information stored in the large-capacity memory 18 can be shared and used by a plurality of application devices when the modem card 10 is simply removed from the digital camera 67 and loaded in the digital video camera 66 in the case where those application devices comprise the specifications of hardware and software corresponding to the modem card 10. The restrictions in sharing the information are similarly applied to other application devices such as the mobile telephone terminal 61 illustrated in FIG. 4. Further, contents produced by the user him/herself by means of the application device owned by the user such as the digital video camera 66 may be combined with the information transferred from the modem card 10 (not only the latitude/longitude data but also information of neighboring well-known spots), and then stored in the application device. As a result, the user can obtain high-value-added information in comparison to the contents produced by him/herself, and it is expected that the value of contents supplied by a contents provider is improved when the user provides the high-value-added information to the provider.

### INDUSTRIAL APPLICABILITY

The modem card according to the present invention and the modem card utilization system wherein the modem card according to the present invention is used are applicable to VoIP terminals of a mobile telephone terminal, a PC, a PDA, a digital camera, a game machine and the like, and various AV devices.

What is claimed is:

1. A modem card comprising:
a communication unit for performing communication with an external communication device;
an authentication unit for authenticating a subscription right for communication;
a position detector for detecting information of a current position; and
an interface for transmitting and receiving input and output signals between an application device selected as a communication terminal from a group of application devices and the communication unit and the position detector based on a standardized signal mode.

2. The modem card as claimed in claim 1, further comprising:
a connection terminal portion which has terminals standardized so as to be coupled with all of the application devices constituting the group of application devices and which is to be coupled with any of the application devices through the terminals so that the signals are transmitted and received therebetween, wherein
the authentication unit authenticates the subscription right for communication via the communication unit by contacting a communication device of a communication carrier which is an example of the external communication device, and
the position detector provides the information of the current position to the application device via the interface.

3. The modem card as claimed in claim 1, further comprising:
a first memory for memorizing information relating to features of the application device; and
a power supply for supplying power for sustaining the first memory to the first memory.

4. The modem card as claimed in claim 3, wherein
the information relating to the features of the application device is a call-arrival status in audio communication.

5. The modem card as claimed in claim 1, further comprising a second memory for memorizing an incoming-call register in audio communication.

6. The modem card as claimed in claim 1, further comprising a detector for detecting the fact that the modem card is illegally removed from the application device without procedures predetermined on the application-device side, wherein
the communication unit transmits the detection result obtained by the detector to a receiver of a predetermined institution previously registered as a recipient of the detection result.

7. The modem card as claimed in claim 1, wherein
the authentication unit authenticates the subscription right for communication by means of SIM (subscriber identify module).

8. The modem card as claimed in claim 1, wherein
the position detector detects the current position by means of GPS (global positioning system).

9. The modem card as claimed in claim 1, wherein
the interface conforms to SDIO (secure digital input/output).

10. The modem card as claimed in claim 1, further comprising a third memory for storing data used for application software installed in the application device.

11. The modem card as claimed in claim 10, wherein
the communication unit downloads the data from the Internet and stores the downloaded data in the third memory.

12. The modem card as claimed in claim 10, wherein
the data is fetched into an arbitrary external device from an external recording medium such as CD-ROM or the Internet and transferred from the external device to the third memory.

13. The modem card as claimed in claim 10, wherein
the data includes any of map information, sightseeing spot information, transportation service information and shopping information.

14. The modem card as claimed in claim 10, further comprising a data transfer unit for extracting the data relating to the information of the current position detected by the position detector from the third memory and transferring the extracted data to the application device.

15. A modem card utilization system, wherein
the modem card as claimed in claim 1 is used as a modem card used for performing communication via a public wireless network based on a contract for a single communication line agreed on with a communication carrier, and
the modem card is shared and used by a group of application devices as the modem card used for performing communication via the public wireless network.

16. An application device used in the modem card utilization system as claimed in claim 15, comprising a card slot coupled with the modem card as claimed in claim 1 so as to transmit and receive signals.

17. The modem card utilization system as claimed in claim 10, wherein
the modem card extracts the data stored in the third memory based on a user's instruction and transfers the extracted data to the application device, and
the application devices appends the data transferred from the modem card to contents to be data-processed in the application device.
